(19) United States
(12) Patent Application Publication
(10) Pub. No.: US 2007/0052261 A1
(43) Pub. Date: Mar. 8, 2007

(54) Multiple part automobile body

(75) Inventors: Gerald Andre, Amberieu en Bugey (FR); Dominique Delavalle, Pont d'Ain (FR); Jerome Fillon, Lyon (FR)

Correspondence Address: OLIFF & BERRIDGE, PLC, P.O. BOX 19928, ALEXANDRIA, VA, 22320, US

(73) Assignee: COMPAGNIE PLASTIC OMNIUM, Lyon (FR)

(21) Appl. No.: 11/515,009

(22) Filed: Sep. 5, 2006

(30) Foreign Application Priority Data
Sep. 2, 2005 (FR) 0509018

(51) Int. Cl. B60J 7/00

(52) U.S. Cl. 296/193.04

(57) ABSTRACT

The invention relates to a motor vehicle body-in-white comprising a bottom portion referred to as a frame, made up of at least of a front unit including the dash panel, and a rear unit including the side rails. The body also comprises fastener means for fastening the rear unit to the front unit, suitable for assembling the rear unit to the front unit in at least two distinct positions relative to the front unit, these two positions being offset by a given length (L) in the longitudinal direction of the vehicle.

The present invention relates to a motor vehicle body-in-white comprising a plurality of portions.

In the state of the art, there exists a motor vehicle body-in-white comprising a bottom portion known as a frame made up of a rear unit having the side rails and a front unit having the dash panel.

The side rails are the side portions of the frame that extend from the rear wheel at the rear end of the vehicle, while the dash panel is shaped to separate the cabin at driver level from the engine compartment.

In conventional manner, motor vehicles of a given model are manufactured in several versions of different lengths: station wagons, sedan, coupé, etc. for which the manufacturer modifies the external structure of the vehicle but uses as many components as possible that are common to all of the versions, in order to reduce manufacturing costs.

The frame of the body-in-white is a portion of the vehicle that is invisible for the user and therefore forms part of those elements that remain common to the different versions of a given vehicle, since it does not affect the exterior design thereof.

Nevertheless, there are variations in length between the different versions. For example, with numerous manufacturers, the station wagon version of a vehicle is longer than the other versions. Using a standard frame for making all of the versions of a given vehicle is thus difficult. In the state of the art, this difference in length gives rise to a rear unit being manufactured that is longer and that is specific to the station wagon version of the motor vehicle.

Thus, although certain parts are common to all of the versions of a given vehicle, specific parts of the rear unit of the body-in-white need to be manufactured for the station wagon version, thus giving rise to higher manufacturing costs, particularly during the step of stamping sheet metal. This step indeed requires machine tools to be used that are very expensive and that permit little adaptation. Manufacturing an additional rear unit that is specific to the station wagon version thus requires investment in new machines that will be used solely for manufacturing this specific rear unit.

A particular object of the invention is to remedy that drawback by providing a body-in-white that is suitable for being used for all of the versions independently of their length.

To this end, the invention provides a motor vehicle body-in-white comprising a bottom portion referred to as a frame, made up of at least of a front unit including the dash panel, and a rear unit including the side rails, wherein the body-in-white includes fastener means for fastening the rear unit to the front unit, suitable for assembling the rear unit to the front unit in at least two distinct positions relative to the front unit, these two positions being offset by a given length (L) in the longitudinal direction of the vehicle.

An advantage of the invention is that it enables a standard body-in-white to be manufactured regardless of the length of the motor vehicle for which the body-in-white is intended.

Investment associated with purchasing new machine tools for stamping is thus avoided. Management costs are also saved, since only one type of rear unit is used.

Optionally, the front unit of the body-in-white includes rear portions of the sills of the underbody, where the sills are the side portions of the frame extending between the front wheels and the rear wheels, and the front unit includes front portions of the sills, that are complementary to the rear portions.

Advantageously, the rear unit of the body-in-white includes at least one opening extending between the rear portions of the underbody and the heel-board cross-member, serving to define the front of the rear passenger seat, and leaving access to the inside of the body from the outside.

This opening, which takes the place of a metal floor that is usually welded to the sills and to the side rails, makes it possible to save on metal material that is not of any use when the shorter sedan version of the vehicle is manufactured, and also saves vehicle weight under such circumstances. A suitable floor can be fitted thereafter, after assembling two bodies.

Advantageously, the front unit of the body-in-white includes a front floor welded to the sills, and under the front floor, a connection interface enabling a rear floor to be fitted in two distinct positions that are offset by a given length (L) in the longitudinal direction of the vehicle.

Thus, in the same manner as for the rear unit, the floor that is fitted may be standard for all versions of the motor vehicle, thereby providing additional savings.

Optionally, the connection interface is a track for adhesive.

Optionally, the fastener means for fastening the front unit to the rear unit comprise welding or screw-fastener means.

### DESCRIPTION OF AN EXAMPLE

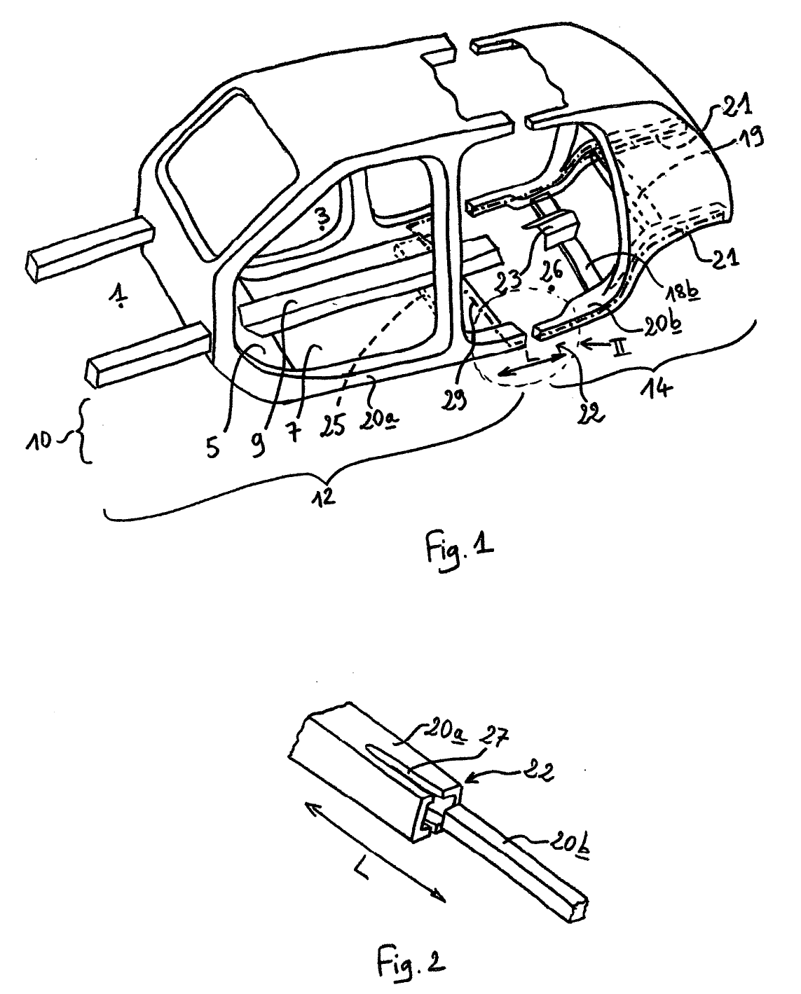

FIG. 1 is a perspective view of a frame in an embodiment of the invention; and

FIG. 2 is an enlarged view of detail II in FIG. 1.

The frame shown in the drawing comprises a front unit 12 and a rear unit 14.

The front unit 12 forms the front of the motor vehicle, in particular the engine compartment 1 and a portion of the cabin 3 that includes the dash panel 5 of the vehicle. It also comprises front portions 20a of the sills of the underbody of the motor vehicle and a front floor 7 made of sheet metal, extending between said front portions 20a and connected to said front portions 20a by welding. The front floor 7 includes a front portion 9 of a tunnel extending in the longitudinal direction of the motor vehicle and enabling the floor to be reinforced in the event of a frontal impact, and also enabling functional elements of the vehicle to pass under the body.

The rear unit 14 forms the rear of the motor vehicle. It comprises in particular side rails 21 of the vehicle and rear portions 20b of the sills of the underbody, complementary to the front portions 20a, and also cross-members 18b, 19 extending transversely between the side rails 21. The rear unit also comprises a rear opening 26 providing access to the inside from outside the body, and enabling a floor to be fitted to the rear unit by being inserted between the cross-members 18b and 19.

A body-in-white with an opening for inserting a floor presents numerous advantages.

During manufacture of the motor vehicle, during the step of performing surface treatment (during which the body is cleaned and then immersed in various baths), the surface area of such a body-in-white for treatment is reduced. This makes it possible to reduce the quantity of bath solution that is used and thus to reduce the costs associated with this treatment step in significant manner, e.g. during the sub-steps of cataphoresis or of applying anti-rust solution. In addition, while the body is being immersed in the treatment baths, the openings formed therein serve to increase the speed at which the solutions are evacuated, and thus achieve gains in productivity.

In addition, such a body-in-white provides easier access for welding cross-members and side rails because the floor is not yet fitted, and makes it possible to reduce the length of the welding clamps.

It is also guaranteed that the floor, and thus the cabin is isolated from the wheels of the vehicle, thereby providing greater comfort for passengers.

The rear unit also has a rear portion 23 of a tunnel situated between the rear portions 20b of the sills and connected to the rear portions of the underbody by the heel-board cross-member 18b.

As can be seen in FIG. 2, the front portions 20a of the sills are constituted by front section members forming hollow bodies of given shape, e.g. essentially of rectangular section. The rear portions 20b of the underbody are likewise constituted by rear section members forming hollow bodies, of shape identical to that of the front section members but of dimensions that are slightly smaller. The person skilled in the art can determine the dimensions for the front and rear portions of the underbody as a function of stresses associated with the motor vehicle, so that the vehicle can comply with the safety requirements to which it is subjected.

Similarly, the front and rear portions 9 and 23 of the tunnel are identical in shape, but the dimensions of the rear portion are slightly smaller than those of the front portion.

Thus, when the front and rear units 12 and 14 of the body are assembled together, the rear section members 20b are received in the front section members 20a of the sills and are suitable for sliding inside said front section members because their shapes match. Similarly, the rear portion 23 of the tunnel is inserted under the front portion 9 thereof and is suitable for sliding relative to the front portion. Thus, the body-in-white of the invention forms a telescopic frame enabling the length of the motor vehicle to be adjusted, in particular in terms of wheel base, by using fastener means 22 constituted by the section members 20a, 20b and the tunnel portions 9, 23.

It should be observed that the sum of the lengths of the front and rear portions of the sills is naturally shorter when the vehicle is at its final wheel base, since the rear portions of the sills are received in the front portions over a certain length.

The front and rear portions of the underbody and of the tunnel are secured to each other by welding. For this purpose, the front portions 20a of the sills include recesses 27 enabling the welding to take place.

The front and rear portions may also be connected together by screw-fastening or by any other means enabling the body-in-white to be assembled so as to possess sufficient stiffness.

The fastener means 22 enable the front and rear units to be assembled together in at least two distinct positions that are spaced apart by a length (L) in the longitudinal direction of the vehicle, so as to make it possible to use the same body-in-white to build vehicles of different lengths.

The body-in-white of the invention also has means for fastening a rear floor that is fitted to the body, which means may comprise a connection interface, e.g. a track for adhesive, represented by a chain-dotted line 29 in FIG. 1, disposed under the front floor, the side rails, and the sills, and possibly under the rear portion of the tunnel.

This connection interface makes it possible to fit the rear floor in two positions that are offset by a length (L) in the longitudinal direction of the vehicle so as to adapt a single floor for fitting to the body-in-white for vehicles of different lengths.

Envisaged Alternatives or Generalizations

The above-described body-in-white comprises two units 12 and 14. Nevertheless, the invention also extends to a motor vehicle body made up of a plurality of portions, the various portions being suitable for arrangement relative to one another in variable manner. A three-portion body-in-white would make it possible, for example, to vary the space provided for each door.

Similarly, the length of the front and rear portions of the underbody and of the tunnel are variable. By way of example, the rear unit may extend as far as the dashboard of the motor vehicle.

1. A motor vehicle body-in-white comprising a bottom portion referred to as a frame, made up of at least of a front unit including the dash panel, and a rear unit including the side rails, wherein the body-in-white includes fastener means for fastening the rear unit to the front unit, suitable for assembling the rear unit to the front unit in at least two distinct positions relative to the front unit, these two positions being offset by a given length (L) in the longitudinal direction of the vehicle.

2. A body-in-white according to claim 1, in which the rear unit includes rear portions of the sills of the underbody and the front unit includes front portions of the sills, complementary to the rear portions.

3. A body-in-white according to claim 2, in which the rear unit includes at least one opening extending between the portions of the sills of the underbody and the heel-board cross-member, leaving access to the inside from the outside of the body.

4. A body-in-white according to claim 3, in which the front unit of the body-in-white includes a front floor welded to the sills of the underbody, and under the front floor a connection interface enabling a rear floor to be fitted in two distinct positions that are offset by a given length (L) in the longitudinal direction of the vehicle.

5. A body-in-white according to claim 4, in which the connection interface enabling a rear floor to be fitted under the front floor is a track for adhesive.

6. A body-in-white according to claim 1, in which the fastener means for fastening the front unit to the rear unit comprise means for fastening by welding or by screw-fastening.
